(19) United States
(12) Patent Application Publication
(10) Pub. No.: US 2004/0033928 A1
(43) Pub. Date: Feb. 19, 2004

(54) Method of reblending detergent tablets

(75) Inventors: Serge Eric Salager, Brookline, MA (US); Dimitri Kristof Vanspauwen, Antwerpen (BE); Jose Luis Vega, Strombeek-Bever (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/427,510

(22) Filed: Apr. 30, 2003

Related U.S. Application Data
(63) Continuation of application No. PCT/US01/51378, filed on Oct. 26, 2001.

(30) Foreign Application Priority Data
Oct. 31, 2000 (EP) 00870254.0
Oct. 31, 2000 (EP) 00870252.4
Oct. 31, 2000 (EP) 00870253.2
Jan. 19, 2001 (EP) 01870013.8
Jan. 19, 2001 (EP) 01870012.0

(51) Int. Cl. C11D 17/00

(52) U.S. Cl. 510/446; 510/447

(57) ABSTRACT

The present invention relates to a multi-phase detergent composition of compressed particulate matter, wherein the average particle density of one phase differs from the average particle density of at least one other phase by at least 25 g/l.

The phases of the compositions of the present invention are easy to separate and avoid excessive contamination which would cause problems for reblend operations.

The present invention also relates to a method of separating the phases of a multi-phase detergent compositions of compressed particulate matter, wherein the average particle density of one phase differs from the average particle density of at least one other phase by at least 25 g/l, said method comprising the steps:

(a) breaking up the compressed composition into particles, and

(b) separating phases on the basis of their density.

### CROSS REFERENCE TO RELATED APPLICATIONS

This is a continuation of International Application PCT/US01/51378 with an international filing date of Oct. 26, 2001, published in English under PCT Article 21(2) which claims benefit of European Patent Application No. 00870254.0, filed Oct. 31, 2000, European Patent Application No. 00870252.4, filed Oct. 31, 2000, European Patent Application No. 00870253.2, filed Oct. 31, 2000, European Patent Application No. 01870013.8, filed Jan. 19, 2001, and European Patent Application No. 01870012.0, filed Jan. 19, 2001.

### TECHNICAL FIELD

The present invention relates to a method of reblending tablets and to detergent tablets suitable for this method.

### BACKGROUND OF THE INVENTION

Detergent tablet compositions are known in the art and are understood to hold several advantages over detergent compositions in particulate form, such as ease of dosing, handling, transportation and storage. Consumers particularly like the convenience of a shaped detergent composition that they can dose via the dispensing drawer.

Multi-phase tablet have the advantage that they allow essentially incompatible ingredients to be formulated in a single dosage unit. The tablet can be designed to keep incompatible ingredients physically separate and to sequentially release those ingredients. For example, it is desirable to formulate a single-dose composition that comprises both surfactant and fabric softener. However, many of the commonly used surfactants will form complexes with the fabric softener materials leading to poor cleaning, poor softening and, possibly, residues on the fabric. Therefore, any composition comprising both materials must either be formulated using a limited number of compatible materials or be designed to sequentially release said ingredients, thereby avoiding the problems of incompatibility.

Tablets are usually prepared by pre-mixing components of a detergent composition and forming the pre-mixed detergent components into a tablet using any suitable equipment, preferably a tablet press. Multi-phase tablets are typically prepared by compressing a first composition in a tablet press to form a substantially planar first layer. A further detergent composition is then delivered to the tablet press on top of the first layer. This second composition is then compressed to form another substantially planar second layer.

A certain number of tablets produced by any method do not meet the quality criteria to allow them to be shipped to the trade. For example, damaged tablets, tablets with bad aesthetics, tablets with unacceptable levels of chemicals etc. To minimize costs and make efficient use of resources the rejected tablets should be recycled. When the tablet is of uniform composition then the rejects may simply be crushed up and the particulate matter added back into the premix. However, when you have two or more different phases made from compressed particulate material and comprising different materials, the reblend process becomes more complicated because these phases must be separated and reblended back into their respective premixes.

It is an object of the present invention to provide a multi-phase detergent composition of compressed particulate material that is designed to ameliorate the problems associated with reblending such tablets. The present invention also provides a method separating the phases of multi-phase detergent tablets.

### SUMMARY OF THE INVENTION

The present invention relates to a multi-phase detergent composition of compressed particulate matter, wherein the average density of the particles of one phase differs from the average density of the particles of at least one other phase by at least 25 g/l.

The phases of the compositions of the present invention are easy to separate and avoid excessive contamination which would cause problems for reblend operations.

The present invention also relates to a method of separating the phases of a multi-phase detergent composition of compressed particulate matter, wherein the average density of the particles of one phase differs from the average density of the particles of at least one other phase by at least 25 g/l, said method comprising the steps:

(a) breaking up the compressed composition into particles, and

(b) separating phases on the basis of their density.

The compressed particulate matter of the present invention can be in the form of granules, beads, noodles, pellets, and mixtures thereof. The particles are preferably solid particles but may be, for example, liquid or gel filled beads.

### DETAILED DESCRIPTION OF THE INVENTION

The multi-phase detergent compositions of the present invention are made from compressed particulate matter. The average density of the particles of one phase of the composition differs from the average density of the particles of at least one other phase by at least 25 g/l. Preferably the average density of the phases differs by at least 50 g/l, more preferably at least 100 g/l.

The density of the particles can be measured using the ASTM method D4892-89 “Standard Test Method for Density of Solid Pitch (Helium Pycnometer Method)”.

The detergent compositions herein can be any suitable shape such as hexagonal, square, rectangular, cylindrical, spherical etc. Preferably, the compositions herein are rectangular or square as this facilitates their use in the dispensing drawer of automatic washing machines.

The phases herein can be in any suitable arrangement. EP-A-055,100 shows some suitable multi-phase forms. Preferably, the detergent composition herein has two phases. These are preferably arranged in layers or, more preferably, with one phase inserted into a mould in the other phase. If the composition herein comprises more than two phases it is preferred, but not essential, that the average density of the each of the phases differs from each of the other phases by at least 25 g/l

The present invention is particularly useful for multi-phase tablets made from compressed particulate. Multi-phase detergent tablets are typically prepared by compressing a first composition in a tablet press to form a first phase. A further composition is then delivered to the tablet press and compressed on top of the first phase. Preferably the principal ingredients are used in particulate form. Preferably the tablets are compressed at a force of less than 10000 N/cm², more preferably not more than 3000 N/cm², even more preferably not more than 750 N/cm². Indeed, the more preferred embodiments of the present invention are compressed with a force of less than 500 N/cm². Generally, the compositions herein will be compressed with relatively low forces to enable them to disintegrate quickly. Suitable tabletting equipment includes a standard single stroke or a rotary press (such as is available form Courtoy®, Korsch®, Manesty® or Bonals®) or those described in WO-A-00/10800. Preferably the tablets are prepared by compression in a tablet press capable of preparing a tablet comprising a mould. Multi-phase tablets can be made using known techniques. A preferred tabletting process using a double punch principle (also described as annular punches with a second core punch build within) comprises the steps of:

i) Lowering the core punch and feeding the core phase of the tablet into the resulting cavity,

ii) Lowering the whole punch and feeding the annular phase into the resulting cavity,

iii) Raising the core punch up to the annular punch level (this step can happen either during the annular phase feeding or during the compression step).

iv) Compressing both punches against the compression plate. A pre-compression step can be added to the compression phase. At the end of the process, both punches are at the same level.

The tablet is then ejected out of the die cavity by raising the punch system to the turret head level. The order of events can change depending on the final result that is desired. Tablets can also be made using double punch systems (one for the lower punch and one for the upper punch).

Another preferred form of composition herein is particulate matter contained with a film material, often known as a pouch. As used herein the term “pouch” means a closed structure, made of a water-soluble film, comprising two or more phases of particulate matter. The pouch can be of any form, shape and material which is suitable to hold the composition, e.g. without allowing substantial release of the composition from the pouch prior to contact of the pouch to water. The exact execution will depend on, for example, the type and amount of the composition in the pouch, the number of compartments in the pouch, the characteristics required from the pouch to hold, protect and deliver or release the phases. Preferably, the pouch as a whole is stretched during formation and/or closing of the pouch, such that the resulting pouch is at least partially stretched.

Preferred water-soluble films for use herein include polymers, copolymers, or derivatives thereof selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferably polyvinyl alcohols, polyvinyl alcohol copolymers, and hydroxypropyl methyl cellulose (HPMC). Highly preferred water-soluble films are films which comprise PVA polymers and that have similar properties to the film known under the trade reference M8630, as sold by Chris-Craft Industrial Products of Gary, Id., US or PT-75, as sold by Aicello of Japan.

The particulate material used for making the compositions of this invention can be made by any particulation or granulation process. An example of such a process is spray drying (in a co-current or counter current spray drying tower) which typically gives low bulk densities of 600 g/l or lower. Particulate materials of higher bulk density can be prepared by a continuous granulation and densification process (e.g. using Lodige® CB and/or Lodige® KM mixers). Other suitable processes include fluid bed processes, compaction processes (e.g. roll compaction), extrusion, as well as any particulate material made by any chemical process like flocculation, crystallisation sentering, etc.

The phases herein can comprise any suitable material. The present invention is particularly useful when the phases comprise ingredients that are essentially incompatible with each other or have different consumer noticeable properties such as smell or colour as this makes it important to avoid contamination during reblending.

Materials that are typically added to detergent compositions include, but are not limited to, surfactants, fabric softening agents, perfumes, chelants, suds suppressing system, dye fixing agents, polymeric dye transfer inhibiting agents, fabric abrasion reducing polymers, wrinkle reducing agents, disintegration aids, enzymes, bleach, builders, and mixtures thereof. These are described in more detail below.

Preferably the phase with the larger geometric mean particle diameter comprises one or more agents selected from fabric softening agents, perfumes, suds-suppressing system, wrinkle reducing agents, chelating agents, dye fixing agents, fabric abrasion reducing polymers, and mixtures thereof. More preferably the phase with the larger geometric mean particle diameter comprises one or more agents selected from fabric softening agents, perfumes, suds-suppressing system and mixtures thereof.

The compositions herein preferably comprise surfactant. Any suitable surfactant may be used. Preferred surfactants are selected from anionic, amphoteric, zwitterionic, nonionic (including semi-polar nonionic surfactants), cationic surfactants and mixtures thereof. The compositions herein preferably have a total surfactant level of from 0.5% to 75% by weight, more preferably from 1% to 50% by weight, most preferably from 5% to 30% by weight of total composition. Detergent surfactants are well-known and fully described in the art (see, for example, “Surface Active Agents and Detergents”, Vol. I & II by Schwartz, Perry and Beach). Some non-limiting examples of suitable surfactants for use herein are:

1. Essentially any nonionic surfactants useful for detersive purposes can be included in the present detergent compositions. Preferred, non-limiting classes of useful nonionic surfactants include nonionic ethoxylated alcohol surfactant, end-capped alkyl alkoxylate surfactant, ether-capped poly(oxyalkylated) alcohols, nonionic ethoxylated/propoxylated fatty alcohol surfactant, nonionic EO/PO condensates with propylene glycol, nonionic EO condensation products with propylene oxide/ethylene diamine adducts.

In a preferred embodiment of the present invention the detergent composition comprises a mixed nonionic surfactant system comprising at least one low cloud point nonionic surfactant and at least one high cloud point nonionic surfactant.

“Cloud point”, as used herein, is a well known property of nonionic surfactants which is the result of the surfactant becoming less soluble with increasing temperature, the temperature at which the appearance of a second phase is observable is referred to as the “cloud point” (See Kirk Othmer's Encyclopedia of Chemical Technology, 3rd Ed. Vol. 22, pp. 360-379).

As used herein, a “low cloud point” nonionic surfactant is defined as a nonionic surfactant system ingredient having a cloud point of less than 30° C., preferably less than 20° C., and most preferably less than 10° C.

Low cloud point nonionic surfactants additionally comprise a polyoxyethylene, polyoxypropylene block polymeric compound. Block polyoxyethylene-polyoxypropylene polymeric compounds include those based on ethylene glycol, propylene glycol, glycerol, trimethylolpropane and ethylenediamine as initiator reactive hydrogen compound. Certain of the block polymer surfactant compounds designated PLURONIC™, REVERSED PLTURONIC™, and TETRONIC™ by the BASF-Wyandotte Corp., Wyandotte, Mich., are suitable in ADD compositions of the invention. Preferred examples include REVERSED PLURONIC™ 25R2 and TETRONIC™ 702, Such surfactants are typically useful herein as low cloud point nonionic surfactants.

As used herein, a “high cloud point” nonionic surfactant is defined as a nonionic surfactant system ingredient having a cloud point of greater than 40° C., preferably greater than 50° C., and more preferably greater than 60° C.

2. Essentially any anionic surfactants useful for detersive purposes are suitable for use herein. These can include salts (including, for example, sodium, potassium, ammonium, and substituted ammonium salts such as mono-, di- and triethanolamine salts) of the anionic sulfate, sulfonate, carboxylate and sarcosinate surfactants. Anionic sulfate surfactants are preferred.

Other anionic surfactants include the isethionates such as the acyl isethionates, N-acyl taurates, fatty acid amides of methyl tauride, alkyl succinates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), N-acyl sarcosinates. Resin acids and hydrogenated resin acids are also suitable, such as rosin, hydrogenated rosin, and resin acids and hydrogenated resin acids present in or derived from tallow oil.

Secondary alkyl sulphate surfactants are also suitable for use herein. These include those disclosed in U.S. Pat. No. 6,015,784. Preferred secondary alkyl sulphate surfactants are those materials which have the sulphate moiety distributed randomly along the hydrocarbyl “backbone” of the molecule. Such materials may be depicted by the structure:

CH₃(CH₂)ₙ(CHOSO₃⁻M⁺)(CH₂)ₘCH₃

wherein m and n are integers of 2 or greater and the sum of m+n is typically form 9 to 17, and M is a water-solublising cation. Preferred secondary alkyl surfactants for use herein have the formula:

CH₃(CH₂)ₓ(CHOSO₃⁻M⁺)CH₃, and

CH₃(CH₂)_{y}(CHOSO₃⁻M⁺)CH₂CH₃

wherein x and (y+1) are intergers of at least 6, and preferably range from 7 to 20, more preferably from 10 to 16. M is a cation, such as alkali metal, ammonium, alkanolammonium, alkaline earth metal or the like. Sodium is typically used. Secondary alkyl surfactants suitable for use herein are described in more detail in U.S. Pat. No. 6,015,784.

3. Suitable amphoteric surfactants for use herein include the amine oxide surfactants and the alkyl amphocarboxylic acids.

4. Zwitterionic surfactants can also be incorporated into the detergent compositions hereof. These surfactants can be broadly described as derivatives of secondary and tertiary amines, derivatives of heterocyclic secondary and tertiary amines, or derivatives of quaternary ammonium, quaternary phosphonium or tertiary sulfonium compounds. Betaine and sultaine surfactants are exemplary zwitterionic surfactants for use herein.

Suitable betaines are those compounds having the formula R(R¹)₂N⁺R²COO⁻ wherein R is a C₆-C₁₈ hydrocarbyl group, each R¹ is typically C₁-C₃ alkyl, and R² is a C₁-C₅ hydrocarbyl group. Preferred betaines are C₁₂-C₁₈ dimethyl-ammonio hexanoate and the C₁₀-C₁₈ acylamidopropane (or ethane) dimethyl (or diethyl) betaines. Complex betaine surfactants are also suitable for use herein.

5. Cationic ester surfactants used in this invention are preferably water dispersible compound having surfactant properties comprising at least one ester (i.e. —COO—) linkage and at least one cationically charged group. Other suitable cationic ester surfactants, including choline ester surfactants, have for example been disclosed in U.S. Pat. No. 4,228,042, U.S. Pat. No. 4,239,660 and U.S. Pat. No. 4,260,529.

Suitable cationic surfactants include the quaternary ammonium surfactants selected from mono C₆-C₁₆, preferably C₆-C₁₀ N-alkyl or alkenyl ammonium surfactants wherein the remaining N positions are substituted by methyl, hydroxyethyl or hydroxypropyl groups.

Preferred surfactants for use herein are selected from anionic sulphonate surfactnats (particularly linear alkylbenzene sulphonates), anionic sulphate surfactants (particularly C₁₂-C₁₈ alkyl sulphates), secondary alkyl sulphate surfactants, nonionic surfactants and mixtures thereof.

A highly preferred agent for use herein is perfume. In the context of this specification, the term “perfume” means any odoriferous material or any material which acts as a malodour counteractant. In general, such materials are characterized by a vapour pressure greater than atmospheric pressure at ambient temperatures. The perfume or deodorant materials employed herein will most often be liquid at ambient temperatures, but also can be solids such as the various tamphoraceous perfumes known in the art. A wide variety of chemicals are known for perfumery uses, including materials such as aldehydes, ketones, esters and the like. More commonly, naturally occurring plant and animal oils and exudates comprising complex mixtures of various chemicals components are known for use as perfumes, and such materials can be used herein. The perfumes herein can be relatively simple in their composition or can comprise highly sophisticated, complex mixtures of natural and synthetic chemical components, all chosen to provide any desired odour.

The perfume component of the present invention may comprise an encapsulate perfume, a properfume, neat perfume materials, and mixtures thereof.

Perfumes which are normally solid can also be employed in the present invention. These may be admixed with a liquefying agent such as a solvent prior to incorporation into the particles, or may be simply melted and incorporated, as long as the perfume would not sublime or decompose upon heating.

Perfume also encompasses the use of materials which act as malodour counteractants. These materials, although termed “perfumes” herein, may not themselves have a discernible odour but can conceal or reduce any unpleasant doors. Examples of suitable malodour counteractants are disclosed in U.S. Pat. No. 3,102,101.

The perfume component may also comprise a pro-perfumes. Pro-perfumes are perfume precursors which release the perfume on interaction with an outside stimulus for example, moisture, pH, chemical reaction. Pro-perfumes suitable for use herein include those known in the art. Examples can be found in U.S. Pat. No. 4,145,184, U.S. Pat. No. 4,209,417, U.S. Pat. No. 4,545,705, U.S. Pat. No. 4,152,272, U.S. Pat. No. 5,139,687 and U.S. Pat. No. 5,234,610.

The present compositions preferably comprise perfume component at a level of from 0.05% to 15%, preferably from 0.1% to 10%, most preferably from 0.5% to 5% by weight.

It is preferred that the compositions herein comprise a disintegration aid. As used herein, the term “disintegration aid” means a substance or mixture of substances that has the effect of hastening the dispersion of the matrix of the present compositions on contact with water. This can take the form of a substances which hastens the disintegration itself or substances which allow the composition to be formulated or processed in such a way that the disintegrative effect of the water itself is hastened. For example, suitable disintegration aid include clays that swell on contact with water (hence breaking up the matrix of the compositions) and coatings which increase tablet integrity allowing lower compression forces to be used during manufacture (hence the tablets are less dense and more easily dispersed. Any suitable disintegration aid can be used but preferably they are selected from disintegrants, coatings, effervescents, binders, clays, highly soluble compounds, cohesive compounds, and mixtures thereof.

1. The compositions herein can comprise a disintegrant that will swell on contact with water. Possible disintegrants for use herein include those described in the Handbook of Pharmaceutical Excipients (1986). Examples of suitable disintegrants include clays such as bentonite clay; starch: natural, modified or pregelatinised starch, sodium starch gluconate; gum: agar gum, guar gum, locust bean gum, karaya gum, pectin gum, tragacanth gum; croscarmylose sodium, crospovidone, cellulose, carboxymethyl cellulose, algenic acid and its salts including sodium alginate, silicone dioxide, polyvinylpyrrolidone, soy polysaccharides, ion exchange resins, and mixtures thereof.

2. The compositions herein can be coated. The coating can improve the mechanical characteristics of a shaped composition while maintaining or improving dissolution. This very advantageously applies to multi-layer tablets, whereby the mechanical constraints of processing the multiple phases can be mitigated though the use of the coating, thus improving mechanical integrity of the tablet. The preferred coatings and methods for use herein are described in EP-A-846,754, herein incorporated by reference. As specified in EP-A-846,754, preferred coating ingredients are for example dicarboxylic acids. Particularly suitable dicarboxylic acids are selected from oxalic acid, malonic acid, succinic acid, glutaric acid, adipic acid, pimelic acid, suberic acid, azelaic acid, sebacic acid, undecanedioic acid, dodecanedioic acid, tridecanedioic acid and mixtures thereof. Most preferred is adipic acid. Preferably the coating comprises a disintegrant, as described hereinabove, that will swell on contact with water and break the coating into small pieces. Preferably the coating comprises a cation exchange resins, such as those sold by Purolite under the names Purolite® C100NaMR, a sodium salt sulfonated poly(styene-divinylbenzene) co-polymer and Purolite® C100CaMR, a calcium salt sulfonated poly(styene-divinylbenzene) co-polymer.

3. The compositions herein can comprise an effervescent. As used herein, effervescency means the evolution of bubbles of gas from a liquid, as the result of a chemical reaction between a soluble acid source and an alkali metal carbonate, to produce carbon dioxide gas. The addition of this effervescent to the detergent improves the disintegration time of the compositions. The amount will preferably be from 0.1% to 20%, more preferably from 5% to 20% by weight of composition. Preferably the effervescent should be added as an agglomerate of the different particles or as a compact, and not as separate particles.

4. Further dispersion aid could be provided by using compounds such as sodium acetate, nitrilotriacetic acid and salts thereof or urea. A list of suitable dispersion aid may also be found in Pharmaceutical Dosage Forms: Tablets, Vol. 1, 2nd Edition, Edited by H. A. Lieberman et al, ISBN 0-8247-8044-2.

5. Non-gelling binding can be integrated to the particles forming the tablet in order to facilitate dispersion. They are preferably selected from synthetic organic polymers such as polyethylene glycols, polyvinylpyrrolidones, polyacetates, water-soluble acrylate copolymers, and mixtures thereof. The handbook of Pharmaceutical Excipients 2nd Edition has the following binder classification: Acacia, Alginic Acid, Carbomer, Carboxymethylcellulose sodium, Dextrin, Ethylcellulose, Gelatin, Guar Gum, Hydrogenated vegetable oil type I, Hydroxyethyl cellulose, Hydroxypropyl methylcellulose, Liquid glucose, Magnesium aluminum silicate, Maltodextrin, Methylcellulose, polymethacrylates, povidone, sodium alginate, starch and zein. Most preferred binder also have an active cleaning function in the wash such as cationic polymers. Examples include ethoxylated hexamethylene diamine quaternary compounds, bishexamethylene triamines or other such as pentaamines, ethoxylated polyethylene amines, maleic acrylic polymers.

6. The compositions herein may also comprise expandable clays. As used herein the term “expandable” means clays with the ability to swell (or expand) on contact with water. These are generally three-layer clays such as aluminosilicates and magnesium silicates having an ion exchange capacity of at least 50 meq/100 g of clay. The three-layer expandable clays used herein are classified geologically as smectites. Example clays useful herein include montmorillonite, volchonskoite, nontronite, hectorite, saponite, sauconitem, vermiculite and mixtures thereof. The clays herein are available under various tradenames, for example, Thixogel #1 and Gelwhite GP from Georgia Kaolin Co., Elizabeth, N.J., USA; Volclay BC and Volclay #325 from American Colloid Co., Skokie, Ill., USA; Black Hills Bentonite BH450 from International Minerals and Chemicals; and Veegum Pro and Veegum F, from R. T. Vanderbilt. It is to be recognised that such smectite-type minerals obtained under the foregoing tradenames can comprise mixtures of the various discrete mineral entities. Such mixtures of the smectite minerals are suitable for use herein.

7. The compositions of the present invention may comprise a highly soluble compound. Such a compound could be formed from a mixture or from a single compound. Examples include salts of acetate, urea, citrate, phosphate, sodium diisobutylbenzene sulphonate (DIBS), sodium toluene sulphonate, and mixtures thereof.

8. The compositions herein may comprise a compound having a Cohesive Effect on the detergent matrix forming the composition. The Cohesive Effect on the particulate material of a detergent matrix forming the tablet or a layer of the tablet is characterised by the force required to break a tablet or layer based on the examined detergent matrix pressed under controlled compression conditions. For a given compression force, a high tablet or layer strength indicates that the granules stuck highly together when they were compressed, so that a strong cohesive effect is taking place. Means to assess tablet or layer strength (also refer to diametrical fracture stress) are given in Pharmaceutical dosage forms: tablets volume 1 Ed. H. A. Lieberman et al, published in 1989. The cohesive effect is measured by comparing the tablet or layer strength of the original base powder without compound having a cohesive effect with the tablet or layer strength of a powder mix which comprises 97 parts of the original base powder and 3 parts of the compound having a cohesive effect. The compound having a cohesive effect is preferably added to the matrix in a form in which it is substantially free of water (water content below 10% (pref. below 5%)). The temperature of the addition is between 10 and 80° C., more pref. between 10 and 40° C. A compound is defined as having a cohesive effect on the particulate material according to the invention when at a given compacting force of 3000N, tablets with a weight of 50 g of detergent particulate material and a diameter of 55 mm have their tablet tensile strength increased by over 30% (preferably 60 and more preferably 100%) by means of the presence of 3% of the compound having a cohesive effect in the base particulate material. An example of a compound having a cohesive effect is sodium diisoalkylbenzene sulphonate.

Another preferred ingredient useful in the compositions herein is one or more enzymes. Suitable enzymes include enzymes selected from peroxidases, proteases, gluco-amylases, amylases, xylanases, cellulases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, dextranase, transferase, laccase, mannanase, xyloglucanases, or mixtures thereof. Detergent compositions generally comprise a cocktail of conventional applicable enzymes like protease, amylase, cellulase, lipase. Enzymes are generally incorporated in detergent compositions at a level of from 0.0001% to 2%, preferably from 0.001% to 0.2%, more preferably from 0.005% to 0.1% pure enzyme by weight of the composition. The above-mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic, halophilic, etc.). Purified or non-purified forms of these enzymes may be used. Nowadays, it is common practice to modify wild-type enzymes via protein/genetic engineering techniques in order to optimize their performance efficiency in the detergent compositions of the invention. For example, the variants may be designed such that the compatibility of the enzyme to commonly encountered ingredients of such compositions is increased. Alternatively, the variant may be designed such that the optimal pH, bleach or chelant stability, catalytic activity and the like, of the enzyme variant is tailored to suit the particular cleaning application. In regard of enzyme stability in liquid detergents, attention should be focused on amino acids sensitive to oxidation in the case of bleach stability and on surface charges for the surfactant compatibility. The isoelectric point of such enzymes may be modified by the substitution of some charged amino acids. The stability of the enzymes may be further enhanced by the creation of e.g. additional salt bridges and enforcing metal binding sites to increase chelant stability. Furthermore, enzymes might be chemically or enzymatically modified, e.g. PEG-ylation, cross-linking and/or can be immobilized, i.e. enzymes attached to a carrier can be applied. The enzyme to be incorporated in a detergent composition can be in any suitable form, e.g. liquid, encapsulate, prill, granulate, or any other form according to the current state of the art.

The compositions herein preferably comprise builders. Suitable water-soluble builder compounds for use herein include water soluble monomeric polycarboxylates or their acid forms, homo- or co-polymeric polycarboxylic acids or their salts in which the polycarboxylic acid comprises at least two carboxylic radicals separated from each other by not more than two carbon atoms, carbonates, bicarbonates, borates, phosphates, and mixtures thereof. The carboxylate or polycarboxylate builder can be monomeric or oligomeric in type although monomeric polycarboxylates are generally preferred. Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid as well as the ether carboxylates and the sulfinyl carboxylates. Polycarboxylates containing three carboxy groups include, in particular, water-soluble citrates, aconitrates and citraconates as well as succinate derivatives such as the carboxymethyloxysuccinates described in GB-A-1,379,241, lactoxysuccinates described in GB-A-1,389,732, amino-succinates described in NL-A-7205873, the oxypolycarboxylate materials described in GB-A-1,387,447. Polycarboxylates containing four carboxy groups suitable for use herein include those disclosed in GB-A-1,261,829. Polycarboxylates containing sulfo substituents include the sulfosuccinates derivatives disclosed in GB-A-1,398,421, GB-A-1,398,422 and U.S. Pat. No. 3,936,448 and the sulfonated pyrolysed citrates described in GB-A-1,439,000. Alicyclic and heterocyclic polycarboxylates include cyclopentane-cis,cis,cis-tetracarboxylates, 2,5-tetrahydrofuran-cis-dicarboxylates, 2,2,5,5-tetra-hydrofuran-tetracarboxylates, 1,2,3,4,5,6-hexane-hexacarboxylates and carboxymethyl derivatives of polyhydric alcohols such as sorbitol, mannitol and xylitol. Aromatic polycarboxylates include mellitic acid, pyromellitic acid and phthalic acid derivatives disclosed in GB-A-1,425,343. Preferred polycarboxylates are hydroxycarboxylates containing up to three carboxy groups per molecule, more particularly citrates. The parent acids of monomeric or oligomeric polycarboxylate chelating agents or mixtures thereof with their salts e.g. citric acid or citrate/citric acid mixtures are also contemplated as useful builders. Examples of carbonate builders are the alkaline earth and alkali metal carbonates, including sodium carbonate and sesqui-carbonate and mixtures thereof with ultra-fine calcium carbonate as disclosed in DE-A-2,321,001. Suitable partially water-soluble builder compounds for use herein include crystalline layered silicates as disclosed in EP-A-164,514 and EP-A-293,640. Preferred crystalline layered sodium silicates of general formula:

NaMSiₓO₂₊₁.yH₂O

wherein M is sodium or hydrogen, x is a number from 1.9 to 4 and y is a number from 0 to 20. Crystalline layered sodium silicates of this type preferably have a two dimensional sheet structure, such as the so called 8-layered structure as described in EP-A-164,514 and EP-A-293,640. Methods of preparation of crystalline layered silicates of this type are disclosed in DE-A-3,417,649 and DE-A-3,742,043. A more preferred crystalline layered sodium silicate compound has the formula δ-Na₂Si₂O₅, known as NaSKS-6™ available from Hoeschst AG.

Suitable largely water-insoluble builder compounds for use herein include the sodium aluminosilicates. Suitable aluminosilicates include the aluminosilicate zeolites having the unit cell formula Na_{z}[(AlO₂)_{z}(SiO₂)_{y}].xH2O wherein z and y are at least 6, the molar ratio of z to y is from 1 to 0.5 and x is at least 5, preferably from 7.5 to 276, more preferably from 10 to 264. The aluminosilicate material are in hydrated form and are preferably crystalline, containing from 10% to 28%, more preferably from 10% to 22% water in bound form. The aluminosilicate zeolites can be naturally occurring materials but are preferably synthetically derived. Synthetic crystalline aluminosilicate ion exchange materials are available under the designations Zeolite A, Zeolite B, Zeolite P, Zeolite X, and Zeolite HS. Preferred aluminosilicate zeolites are colloidal aluminosilicate zeolites. When employed as a component of a detergent composition colloidal aluminosilicate zeolites, especially colloidal zeolite A, provide ehanced builder performance, especially in terms of improved stain removal, reduced fabric encrustation and improved fabric whiteness maintenance. Mixtures of colloidal zeolite A and colloidal zeolite Y are also suitable herein providing excellent calcium ion and magnesium ion sequestration performance.

Fabric softening agents can be used here. Any suitable softening agents may be used herein but preferred are quaternary ammonium agents and/or a clay softening system.

As used herein the term “quaternary ammonium agent’ means a compound or mixture of compounds having a quaternary nitrogen atom and having one or more, preferably two, moieties containing six or more carbon atoms. Preferably the quaternary ammonium agents for use herein are selected from those having a quaternary nitrogen substituted with two moieties wherein each moiety comprises ten or more, preferably 12 or more, carbon atoms. Preferred examples of quaternary ammonium compounds suitable for use in the compositions of the present invention are N,N-di(canolyl-oxy-ethyl)-N,N-dimethyl ammonium chloride, N,N-di(canolyl-oxy-ethyl)-N-methyl,N-(2-hydroxyethyl) ammonium methyl sulfate, N,N-di(canolyl-oxy-ethyl)-N-methyl, N-(2-hydroxyethyl) ammonium chloride and mixtures thereof. Particularly preferred for use herein is N,N-di(canolyl-oxy-ethyl)-N-methyl,N-(2-hydroxyethyl) ammonium methyl sulfate. Although quaternary ammonium compounds are derived from “canolyl” fatty acyl groups are preferred, other suitable examples of quaternary ammonium compounds are derived from fatty acyl groups wherein the term “canolyl” in the above examples is replaced by the terms “tallowyl, cocoyl, palmyl, lauryl, oleyl, ricinoleyl, stearyl, palmityl” which correspond to the triglyceride source from which the fatty acyl units are derived. These alternative fatty acyl sources can comprise either fully saturated, or preferably at least partly unsaturated chains.

Any suitable clay softening system may be used but preferred are those comprising a clay mineral compound and optionally a clay flocculating agent. If present, shaped compositions herein preferably contain from 0.001% to 10% by weight of total composition of clay softening system. The clay mineral compound is preferably a smectite clay compound. Smectite clays are disclosed in the U.S. Pat. No. 3,862,058, U.S. Pat. No. 3,948,790, U.S. Pat. No. 3,954,632 and U.S. Pat. No. 4,062,647. Also, EP-A-299,575 and EP-A-313,146 describe suitable organic polymeric clay flocculating agents.

The compositions herein can comprise chelants/heavy metal ion sequestrants. By heavy metal ion sequestrant it is meant herein components which act to sequester (chelate) heavy metal ions. These components may also have calcium and magnesium chelation capacity, but preferentially they show selectivity to binding heavy metal ions such as iron, manganese and copper. Heavy metal ion sequestrants are used at a level of from 0.005% to 20%, preferably from 0.1% to 10%, more preferably from 0.25% to 7.5% and most preferably from 0.5% to 5% by weight of the compositions. Suitable heavy metal ion sequestrants for use herein include organic phosphonates, such as the amino alkylene poly(alkylene phosphonates), alkali metal ethane 1-hydroxy disphosphonates and nitrilo trimethylene phosphonates. Preferred among the above species are diethylene triamine penta (methylene phosphonate), ethylene diamine tri(methylene phosphonate) hexamethylene diamine tetra(methylene phosphonate) and hydroxy-ethylene 1,1 diphosphonate. Other suitable heavy metal ion sequestrant for use herein include nitrilotriacetic acid and polyaminocarboxylic acids such as ethylenediaminotetracetic acid, ethylenetriamine pentacetic acid, ethylenediamine disuccinic acid, ethylenediamine diglutaric acid, 2-hydroxypropylenediamine disuccinic acid or any salts thereof. Especially preferred is ethylenediamine-N,N′-disuccinic acid (EDDS) or the alkali metal, alkaline earth metal, ammonium, or substituted ammonium salts thereof, or mixtures thereof. Preferred EDDS compounds are the free acid form and the sodium or magnesium salt or complex thereof.

The compositions herein can comprise a suds suppressing system. Suitable suds suppressing systems for use herein may comprise essentially any known antifoam compound, including, for example silicone antifoam compounds, 2-alkyl and alcanol antifoam compounds. Preferred suds suppressing systems and antifoam compounds are disclosed WO-A-93/08876 and EP-A-705 324.

The compositions herein can comprise dye fixing agents (fixatives). These are well-known, commercially available materials which are designed to improve the appearance of dyed fabrics by minimising the loss of dye from the fabrics due to washing. Many dye fixatives are cationic and are based on quaterinised nitrogen compounds or on nitrogen compounds having a strong cationic charge which is formed in situ under the conditions of usage. Cationic fixatives are available under various trade names from several suppliers. Representative trade names include CROSCOLOR PMF and CROSCOLOR NOFF from Crosfield, INDOSOL E-50 from Sandoz, SANDOFIX TPS from Sandoz, SANDOFIX SWE from Sandoz, REWIN SRF, REWIN SRF-O and REWIN DWE from CHT-Beitlich GmbH, Tinofix ECO, Tinofix FRD and Solfin from Ciba-Geigy.

Other suitable cationic dye fixing agents are described in “Aftertreatments for Improving the Fastness of Dyes on Textile Fibres”, Christopher C. Cook, Rev. Prog. Coloration, Vol. XII (1982). Dye fixing agents suitable for use in the present compositions include ammonium compounds such as fatty acid-diamine condensates inter alia the hydrochloride, acetate, metosulphate and benzyl hydrochloride salts of diamine esters. Non-limiting examples include oleyldiethyl aminoethylamide, oleylmethyl diethylenediamine methosulphate, monostearylethylene diamino-trimethylammonium methosulphate. In addition, the N-oxides of tertiary amines, derivatives of polymeric alkyldiamines, polyamine cyanuric chloride condensates, aminated glycerol dichlorohydrins, and mixture thereof.

Another class of dye fixing agents suitable for use herein are cellulose reactive dye fixing agents. The cellulose reactive dye fixatives may be suitably combined with one or more dye fixatives described herein above in order to comprise a “dye fixative system”. The term “cellulose reactive dye fixing agent” is defined herein as a dye fixing agent that reacts with the cellulose fibres upon application of heat or upon a heat treatment either in situ or by the formulator. Cellulose reactive dye fixatives are described in more detail in WO-A-00/15745.

The compositions herein can comprise polymeric dye transfer inhibiting agents. If present, the shaped compositions herein preferably comprise from 0.01% to 10%, preferably from 0.05% to 0.5% by weight of total composition of polymeric dye transfer inhibiting agents. The polymeric dye transfer inhibiting agents are preferably selected from polyamine N-oxide polymers, copolymers of N-vinylpyrrolidone and N-vinylimidazole, polyvinylpyrrolidonepolymers or combinations thereof.

The compositions herein can comprise fabric abrasion reducing polymers. Any suitable fabric abrasion reducing polymers may be used herein. Some examples of suitable polymers are described in WO-A-00/15745.

The compositions herein can comprise wrinkle reducing agents. Any suitable wrinkle reducing agents may be used herein. Some examples of suitable agents are described in WO-A-99/55953.

Another ingredient which may be present is a bleach system, such as salts of percarbonates, particularly the sodium salts, and/or organic peroxyacid bleach precursor, and/or transition metal bleach catalysts, especially those comprising Mn or Fe. It has been found that when the pouch or compartment is formed from a material with free hydroxy groups, such as PVA, the preferred bleaching agent comprises a percarbonate salt and is preferably free form any perborate salts or borate salts. It has been found that borates and perborates interact with these hydroxy-containing materials and reduce the dissolution of the materials and also result in reduced performance. Inorganic perhydrate salts are a preferred source of peroxide. Examples of inorganic perhydrate salts include percarbonate, perphosphate, persulfate and persilicate salts. The inorganic perhydrate salts are normally the alkali metal salts. Alkali metal percarbonates, particularly sodium percarbonate are preferred perhydrates herein. The composition herein preferably comprises a peroxy acid or a precursor therefor (bleach activator), preferably comprising an organic peroxyacid bleach precursor. It may be preferred that the composition comprises at least two peroxy acid bleach precursors, preferably at least one hydrophobic peroxyacid bleach precursor and at least one hydrophilic peroxy acid bleach precursor, as defined herein. The production of the organic peroxyacid occurs then by an in-situ reaction of the precursor with a source of hydrogen peroxide. The hydrophobic peroxy acid bleach precursor preferably comprises a compound having a oxy-benzene sulphonate group, preferably NOBS, DOBS, LOBS and/or NACA-OBS, as described herein. The hydrophilic peroxy acid bleach precursor preferably comprises TAED. Amide substituted alkyl peroxyacid precursor compounds can be used herein. Suitable amide substituted bleach activator compounds are described in EP-A-0170386.

The composition may contain a pre-formed organic peroxyacid. A preferred class of organic peroxyacid compounds are described in EP-A-170,386. Other organic peroxyacids include diacyl and tetraacylperoxides, especially diperoxydodecanedioc acid, diperoxytetradecanedioc acid and diperoxyhexadecanedioc acid. Mono- and diperazelaic acid, mono- and diperbrassylic acid and N-phthaloylaminoperoxicaproic acid are also suitable herein.

Additional ingredients that may be added to the compositions herein include optical brighteners, organic polymeric compounds, alkali metal silicates, colourants, and lime soap dispersants.

The compositions of the present invention are preferably not formulated to have an unduly high pH. Preferably, the compositions of the present invention have a pH, measured as a 1% solution in distilled water, of from 7.0 to 12.5, more preferably from 7.5 to 11.8, most preferably from 8.0 to 11.5.

Method of Separation

The present invention includes a method of separating two or more phases of a composition made from compressed particulate. Said method comprises the steps:

(a) breaking up the compressed composition into particles, and

(b) separating phases on the basis of their density.

The compressed composition can be broken up by any suitable means. The composition is preferably broken using a couple of rotating cylinders with knives built in (Telschig's cutters and Opbouw Messen's Cru-cut® cutters are examples of such equipments). Then the composition is transported to a conventional rotating sieve to allow the separation of the plastic flow packs and then to a lump breaking unit (for example, a Kemutec K1350 sifter®) to further break down eventual pieces of tablets which have not being broken by the cutters.

After particulation the phases of the composition (each one with a different density) can be separated by any suitable means. Preferably, the particles are fed into an air classification equipment such as the RSG ACS cyclones or an sieve-air separation combo system developed by Azo.

Once the phases are separated they can be fed back into their respective premixes and recompressed.

### EXAMPLES

A composition was prepared using the following procedure:

| | % by weight, |
|---|---|
| | of total |
| First phase: | composition |
| Anionic agglomerates 1 | 7.1 |
| Anionic agglomerates 2 | 17.5 |
| Nonionic agglomerates | 9.1 |
| Cationic agglomerates | 4.6 |
| Layered silicate | 9.7 |
| Sodium percarbonate | 12.2 |
| Bleach activator agglomerates | 6.1 |
| Sodium carbonate | 7.27 |
| EDDS/Sulphate particle | 0.5 |
| Tetrasodium salt of Hydroxyethane | 0.6 |
| Diphosphonic acid | |
| Soil release polymer | 0.3 |
| Fluorescer | 0.2 |
| Zinc Phthalocyanine sulphonate encapsulate | 0.03 |
| Soap powder | 1.2 |
| Suds suppresser | 2.8 |
| Citric acid | 4.5 |
| Protease | 1 |
| Lipase | 0.35 |
| Cellulase | 0.2 |
| Amylase | 1.1 |
| Binder spray on system | 3.05 |
| Perfume spray on | 0.1 |
| DIBS (Sodium diisobutylbenzene sulphonate) | 2.1 |

Anionic agglomerates 1 comprise 40% anionic surfactant, 27% zeolite and 33% carbonate

Anionic agglomerates 2 comprise 40% anionic sufactant, 28% zeolite and 32% carbonate

Nonionic agglomerate comprise 26% nonionic surfactant, 6% Lutensit K-HD 96 ex BASF, 40% sodium acetate anhydrous, 20% carbonate and 8% zeolite.

Cationic agglomerate comprise 20% cationic surfactant, 56% zeolite and 24% sulfate

Layered silicate comprises of 95% SKS 6 and 5% silicate

Bleach activator agglomerates comprise 81% Tetraacetylethylene diamine (TAED), 17% acrylic/maleic copolymer (acid form) and 2% water

EDDS/Sulphate particle particle comprise 58% of Ethylene diamineN,N-disuccinic acid sodium salt, 23% of sulphate and 19% water.

Zinc phthalocyanine sulphonate encapsulates are 10% active

Suds suppresser comprises 11.5% silicone oil (ex Dow Corning), 59% zeolite and 29.5% H₂O

Binder spray on system comprises 0.5 parts of Lutensit K-HD 96 and 2.5 parts of Polyethylene glycols (PEG)

| | % by weight, |
|---|---|
| | of total |
| Second phase | composition |
| Softerner and perfume bead | 8.4 |

Perfume beads composition contains 56% expancel 091DE80, 7% silica, 8% perfume, 5% crosslinked polyvinylalcohol (PVA)-borate, 5% water, 18% cationic softener N,N-di(candyl-oxy-ethyl)-N-methyl,N-(2-hydroxyethyl) ammonium methyl sulfate and 1% of laundry compatible Zeneca Monastral blue

Manufacturing:

Manufacturing of the First Phase:

The detergent active composition of the first phase was prepared by admixing the granular components in a mixing drum for 5 minutes to create an homogenous particle mixture. During this mixing, the spray-ons were carried out with a nozzle and hot air using the binder composition described above. The mean particle diameter was 560 μm.

Manufacturing of Phase 2:

The beads of the second phase were manufactured using a Braun food processor with a standard stirrer where the dry mixture described above is added. The mixer was operated at high speed during 1 minute and the mix is poured into a Fuji Paudal Dome Gran DGL1 (Japan) extruder with 3 mm diameter holes in the extruder tip plate and operated at 70 revolutions per minute. The resulting product was added into a Fuji Paudal Marumerizer QJ-230 were it is operated at 1000 revolutions per minute for 5 minutes were a good spheronization was achieved.

In a further step, the beads were coated by a partially insoluble coating described. This was achieved by spraying the beads in a conventional mix drum with 4% (weight beads based) of a mixture of 80% cross linked polyvinyl alcohol-borate and 20% water at 70° C. using a spray nozzle and hot air. The beads are then left in a rotating drum for 60 minutes and hot air was injected in order to evaporate part of the water contained in the PVA coating. The final water content in the bead is mentioned in the bead composition above.

Tablet Manufacturing:

The multi-phase tablet composition was prepared using an Instron 4400 testing machine and a standard die for manual tablet manufacturing. 35 g of the detergent active composition of the first phase was fed into the dye of 41×41 mm with rounded edges that has a ratio of 2.5 mm. The mix was compressed with a force of 1,500 N with a punch that has a suitable shape to form a concave mould of 25 mm diameter and 10 mm depth in the tablet. The shaped punch was carefully removed leaving the tablet into the dye. 4 g of beads that will form the second phase were introduced into the mould left in the first tablet shape and a final compression of 1,700 N was applied to manufacture the multiphase tablet using a flat normal punch. The tablet is then manually ejected from the dye.

In a following step, the tablet made with the process described above were coated by manually dipping them into a molten mixture of coating at 170° C. and let them cool back to room temperature allowing the coating to harden. The composition and percentage of the coating are described in the tablet composition above.

An equivalent of 1 kg of flow-wrapped tablets were processed through a Opbouw Messen cutter and then conveyed to a cylindrical rotating sieve with 10 mm×10 mm openings to separate the plastic flow wraps from the crushed tablets. After the flow wrap separation, the mixture is conveyed to a Kemutec K1350 lump breaker to covert the remaining pieces of tablet into powder.

To classify the particles based on their densities, a laboratory scale equipment made with a transparent column of plastic of 10 cm of diameter was made. The column was connected to a standard vacuum cleaner at the top of the column and has one sieve of 50 microns openings at each side of the column. The flow of air was controlled by the vacuum cleaner own control devise. The set up of the system was made in such a way that the particles with light densities were recuperated in the top of the column and the denser particles at the bottom of the column.

By analyzing each individual particle fraction with a Helium Pycnometer following the ASTM method D4892-89, the denser particle had a density of 1640 g/l and the lighter fraction of 1512 g/l.

These two fractions were then mixed back in the original streams at a level of 10% by weight (in each phase) and a new composition was made following the same procedure indicated above.

What is claimed is:

1. A multi-phase detergent composition of compressed particulate matter, wherein the average particle density of one phase differs from the average particle density of at least one other phase by at least 25 g/l.

2. A detergent composition according to claim 1 wherein the average particle density of one phase differs from the average particle density of at least one other phase by at least 50 g/l.

3. A detergent composition according to claim 1 wherein the average particle density of one phase differs from the average particle density of at least one other phase by at least 100 g/l.

4. A detergent composition according to claim 1 wherein the composition has two phases.

5. A detergent composition according to claim 1 wherein the phases are arranged in layers.

6. A detergent composition according to claim 1 wherein the phases are arranged with one phase inserted into a mould in the other phase.

7. A detergent composition according to claim 1 wherein the composition is in the form of a tablet.

8. A method of separating the phases of a multi-phase detergent compositions of compressed particulate matter, wherein the average particle density of one phase differs from the average particle density of at least one other phase by at least 25 g/l, said method comprising the steps:
(a) breaking up the compressed composition into particles, and
(b) separating phases on the basis of their density.

9. A method according to claim 8 wherein the average particle density of at least one other phase by at least 100 g/l.

10. A method according to claim 8 wherein the separated phases are fed back into their respective premixes and recompressed.
